(19) United States
(12) Patent Application Publication
(10) Pub. No.: US 2012/0185583 A1
(43) Pub. Date: Jul. 19, 2012

(54) METHODS AND APPARATUS FOR ENABLING RELAYING OF PEER DISCOVERY SIGNALS

(75) Inventors: Xinzhou Wu, Monmouth Junction, NJ (US); Shailesh Patil, Bridgewater, NJ (US); Junyi Li, Chester, NJ (US)

(73) Assignee: QUALCOMM Incorporated, San Diego, CA (US)

(21) Appl. No.: 13/008,983

(22) Filed: Jan. 19, 2011

(51) Int. Cl. G06F 15/173

(52) U.S. Cl. 709/224

(57) ABSTRACT

A method of operating a first wireless device includes receiving a peer discovery signal from a second wireless device on a first resource in a set of resources associated with a particular identifier. In addition, the method includes determining whether to relay the peer discovery signal. Furthermore, the method includes sending the peer discovery signal on a second resource in the set of resources upon determining to relay the peer discovery signal. The second resource is associated with the particular identifier and is the same resource on which the peer discovery signal is sent by the second wireless device.

### BACKGROUND

1. Field

The present disclosure relates generally to communication systems, and more particularly, to relaying of peer discovery signals in peer-to-peer communication systems.

2. Background

Peer discovery is an important functionality of a peer-to-peer communication system where all devices identify neighboring devices and services to engage peer to peer communications. Peer discovery has two important performance metrics: peer discovery range and peer discovery energy efficiency. Methods for improving peer discovery range in a peer-to-peer communication system are needed.

### SUMMARY

In an aspect of the disclosure, a method, an apparatus, and a computer program product are provided in which a peer discovery signal is received from a second wireless device on a first resource in a set of resources associated with a particular identifier. In addition, whether to relay the peer discovery signal is determined. Furthermore, the peer discovery signal is sent on a second resource in the set of resources upon determining to relay the peer discovery signal. The second resource is associated with the particular identifier and is the same resource on which the peer discovery signal is sent by the second wireless device.

### BRIEF DESCRIPTION OF THE DRAWINGS

FIG. 1 is a diagram illustrating an example of a hardware implementation for an apparatus employing a processing system.

FIG. 2 is a drawing of a wireless peer-to-peer communications system.

FIG. 3 is a diagram illustrating an exemplary time structure for peer-to-peer communication between the wireless devices.

FIG. 4 is a diagram illustrating the channels in each frame of superframes in one grandframe.

FIG. 5 is a diagram illustrating an operation timeline of a miscellaneous channel and a structure of a peer discovery channel.

FIG. 6 is a diagram for illustrating an exemplary method.

FIG. 7 is another diagram for illustrating an exemplary method.

FIG. 8 is a first diagram for illustrating resources utilized by a first wireless device for relaying/transmitting peer discovery signals and a second wireless device for transmitting peer discovery signals.

FIG. 9 is a second diagram for illustrating resources utilized by a first wireless device for relaying/transmitting peer discovery signals and a second wireless device for transmitting peer discovery signals.

FIG. 10 is a third diagram for illustrating resources utilized by a first wireless device for relaying/transmitting peer discovery signals and a second wireless device for transmitting peer discovery signals.

FIG. 11 is a fourth diagram for illustrating resources utilized by a first wireless device for relaying/transmitting peer discovery signals and a second wireless device for transmitting peer discovery signals.

FIG. 12 is a flow chart of a method of wireless communication.

FIG. 13 is another flow chart of a method of wireless communication.

FIG. 14 is yet another flow chart of a method of wireless communication.

FIG. 15 is a conceptual block diagram illustrating the functionality of an exemplary apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of communication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials.

Accordingly, in one or more exemplary embodiments, the functions described may be implemented in hardware, software, firmware, or any combination thereof If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and Blu-ray disc where disks usually reproduce data magnetically, while discs reproduce data optically with lasers. Combinations of the above should also be included within the scope of computer-readable media. Those skilled in the art will recognize how best to implement the described functionality presented throughout this disclosure depending on the particular application and the overall design constraints imposed on the overall system.

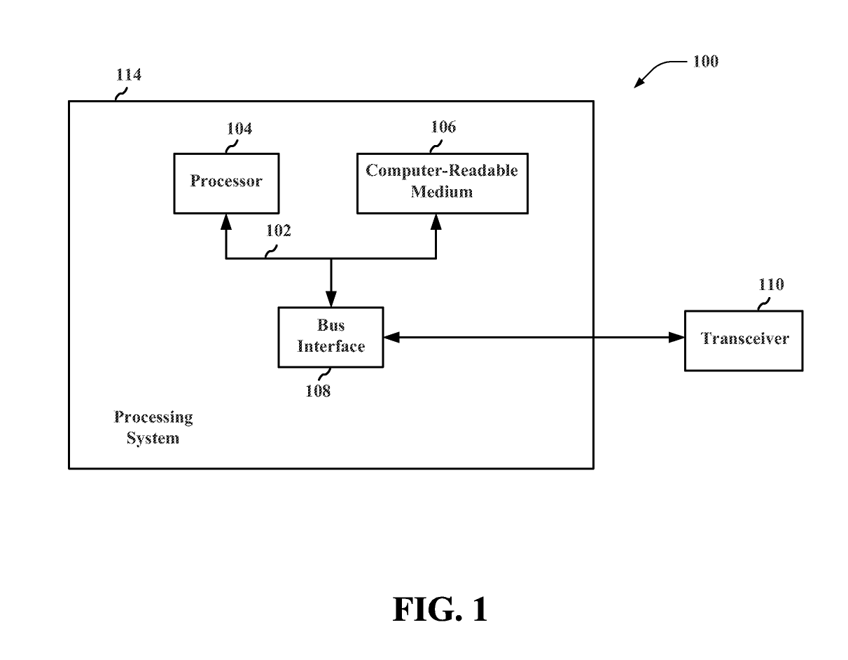

FIG. 1 is a conceptual diagram illustrating an example of a hardware implementation for an apparatus 100 employing a processing system 114. The processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors and/or hardware modules, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatuses over a transmission medium.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

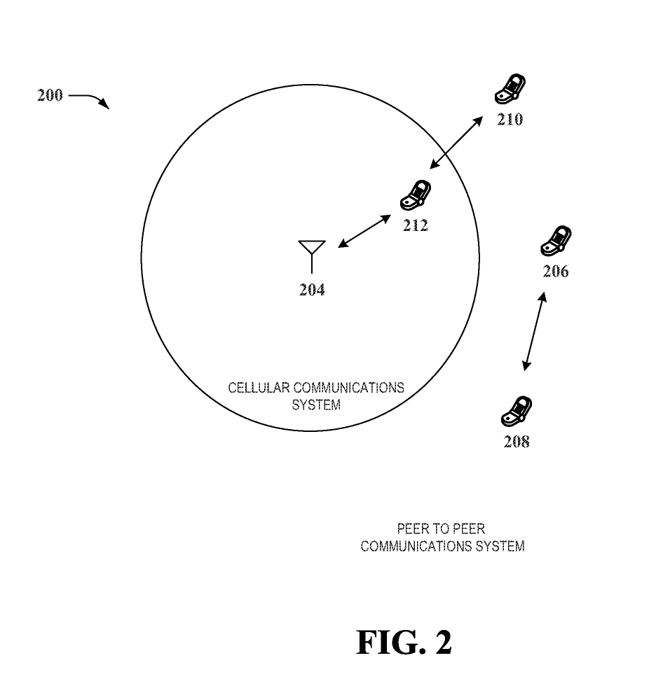

FIG. 2 is a drawing of an exemplary peer-to-peer communications system 200. The peer-to-peer communications system 200 includes a plurality of wireless devices 206, 208, 210, 212. The peer-to-peer communications system 200 may overlap with a cellular communications system, such as for example, a wireless wide area network (WWAN). Some of the wireless devices 206, 208, 210, 212 may communicate together in peer-to-peer communication, some may communicate with the base station 204, and some may do both. For example, as shown in FIG. 2, the wireless devices 206, 208 are in peer-to-peer communication and the wireless devices 210, 212 are in peer-to-peer communication. The wireless device 212 is also communicating with the base station 204.

The wireless device may alternatively be referred to by those skilled in the art as user equipment, a mobile station, a subscriber station, a mobile unit, a subscriber unit, a wireless unit, a wireless node, a remote unit, a mobile device, a wireless communication device, a remote device, a mobile subscriber station, an access terminal, a mobile terminal, a wireless terminal, a remote terminal, a handset, a user agent, a mobile client, a client, or some other suitable terminology. The base station may alternatively be referred to by those skilled in the art as an access point, a base transceiver station, a radio base station, a radio transceiver, a transceiver function, a basic service set (BSS), an extended service set (ESS), a Node B, an evolved Node B, or some other suitable terminology.

The exemplary methods and apparatuses discussed infra are applicable to any of a variety of wireless peer-to-peer communications systems, such as for example, a wireless peer-to-peer communication system based on FlashLinQ, WiMedia, Bluetooth, ZigBee, or Wi-Fi based on the IEEE 802.11 standard. To simplify the discussion, the exemplary methods and apparatus are discussed within the context of FlashLinQ. However, one of ordinary skill in the art would understand that the exemplary methods and apparatuses are applicable more generally to a variety of other wireless peer-to-peer communication systems.

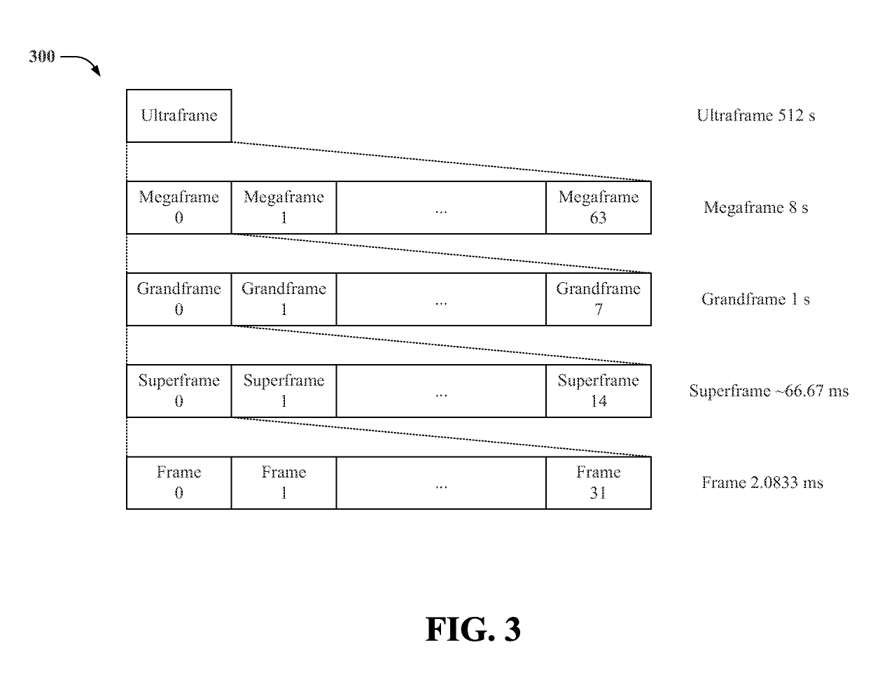

FIG. 3 is a diagram 300 illustrating an exemplary time structure for peer-to-peer communication between the wireless devices 100. An ultraframe is 512 seconds and includes 64 megaframes. Each megaframe is 8 seconds and includes 8 grandframes. Each grandframe is 1 second and includes 15 superframes. Each superframe is approximately 66.67 ms and includes 32 frames. Each frame is 2.0833 ms.

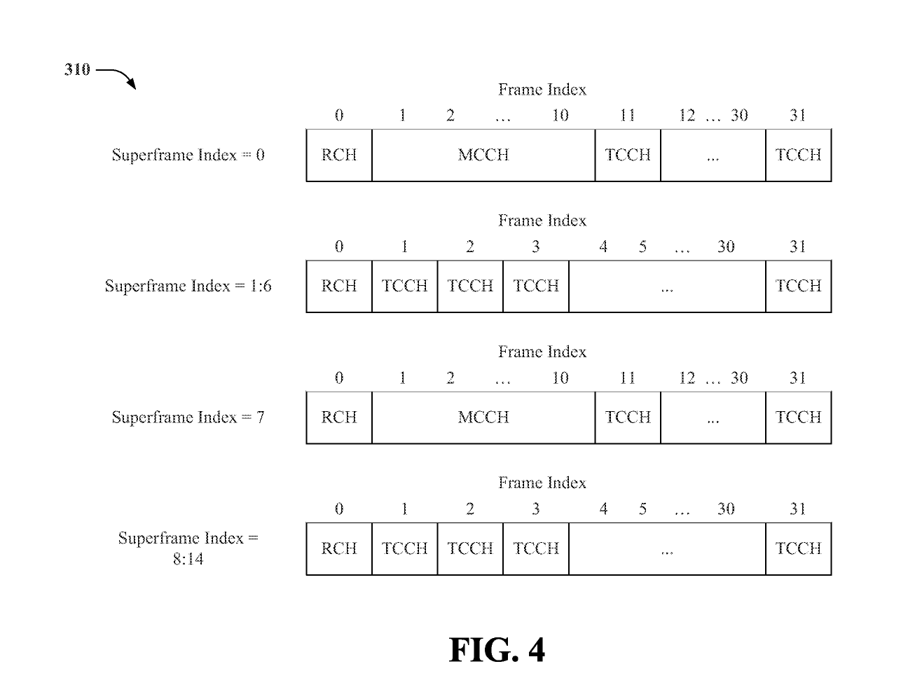

FIG. 4 is a diagram 310 illustrating the channels in each frame of superframes in one grandframe. In a first superframe (with index 0), frame 0 is a reserved channel (RCH), frames 1-10 are each a miscellaneous channel (MCCH), and frames 11-31 are each a traffic channel (TCCH). In the 2^{nd} through 7^{th} superframes (with index 1:6), frame 0 is a RCH and frames 1-31 are each a TCCH. In an 8^{th} superframe (with index 7), frame 0 is a RCH, frames 1-10 are each a MCCH, and frames 11-31 are each a TCCH. In the 9^{th} through 15^{th} superframes (with index 8:14), frame 0 is a RCH and frames 1-31 are each a TCCH. The MCCH of superframe index 0 includes a secondary timing synchronization channel, a peer discovery channel, a peer page channel, and a reserved slot. The MCCH of superframe index 7 includes a peer page channel and reserved slots. The TCCH includes connection scheduling, a pilot, channel quality indicator (CQI) feedback, a data segment, and an acknowledgement (ACK).

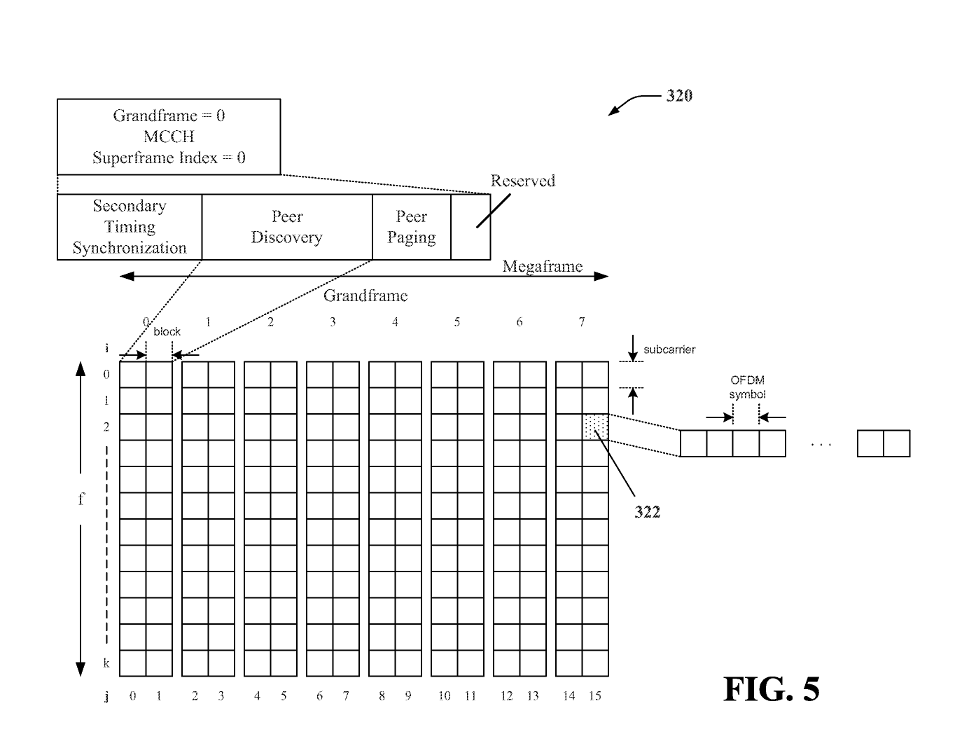

FIG. 5 is a diagram 320 illustrating an operation timeline of the MCCH and an exemplary structure of a peer discovery channel. As discussed in relation to FIG. 4, the MCCH of superframe index 0 includes a secondary timing synchronization channel, a peer discovery channel, a peer paging channel, and a reserved slot. The peer discovery channel may be divided into subchannels. For example, the peer discovery channel may be divided into a long range peer discovery channel, a medium range peer discovery channel, a short range peer discovery channel, and other channels. Each of the subchannels may include a plurality of blocks/resources for communicating peer discovery information. Each block may include a plurality of orthogonal frequency divisional multiplexing (OFDM) symbols at the same subcarrier. FIG. 5 provides an example of a subchannel (e.g., short range peer discovery channel) including blocks in one megaframe, which includes the MCCH superframe index 0 of grandframes 0 through 7. Different sets of blocks correspond to different peer discovery resource identifiers (PDRIDs). For example, one PDRID may correspond to one of the blocks in the MCCH superframe index 0 of one grandframe in the megaframe.

Upon power up, a wireless device listens to the peer discovery channel for a period of time (e.g., two megaframes) and selects a PDRID based on a determined energy on each of the PDRIDs. For example, a wireless device may select a PDRID corresponding to block 322 (i=2 and j=15) in a first megaframe of an ultraframe. The particular PDRID may map to other blocks in other megaframes of the ultraframe due to hopping. In blocks associated with the selected PDRID, the wireless device transmits its peer discovery signal. In blocks unassociated with the selected PDRID, the wireless device listens for peer discovery signals transmitted by other wireless devices.

As discussed supra, in synchronous peer-to-peer systems, a time recurring time-frequency resource is allocated for the purpose of peer discovery. The peer discovery resource is further divided into smaller transmission units, referred to as blocks in FIG. 5. A peer obtains one of the transmission units (i.e., a block) and sends its peer identity signal on the transmission unit. The peer discovery range is limited by two factors: (1) thermal noise at each receiver; and (2) co-channel interference from peer discovery signals transmitted by peers with the same PDRID that are using the same transmission unit. In a thermal limited case, where the number of peers in a peer-to-peer system is far less than the number of transmission units (i.e., PDRIDs), thermal noise is the predominant limit of the transmission range. In an interference limited case, where the number of peers far exceeds the number of PDRIDs, co-channel interference is the predominant limitation. According to an exemplary method, peer discovery range may be increased through a scheme in where peers relay the peer discovery signals transmitted by their peers in their neighborhood. In such a scheme, two main design issues should be addressed to enable relaying: (i) A peer can usually decode multiple peer discovery signals in the peer discovery resources. Which peer discovery signal should a peer choose to relay?; and (ii) Which PDRID should a peer use to transmit the relayed peer discovery signal? The scheme and the design issues are discussed infra.

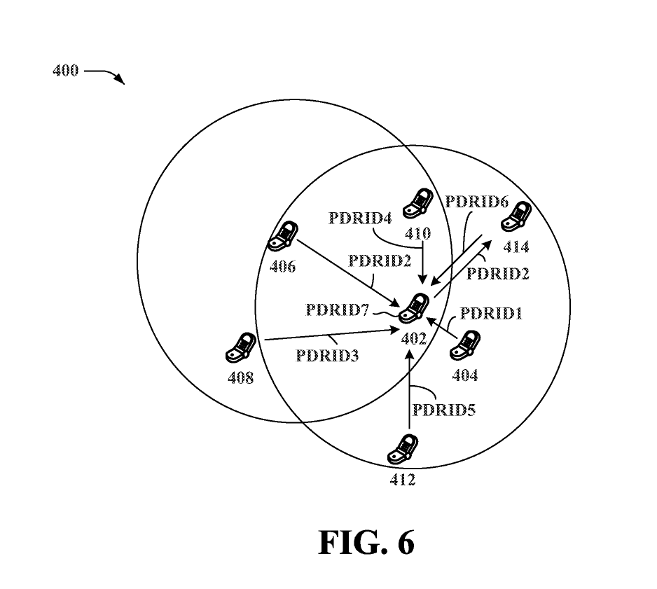

FIG. 6 is a diagram 400 for illustrating an exemplary method for improving peer discovery range in a peer-to-peer communication system by enabling relaying of peer discovery signals. As shown in FIG. 6, the wireless device 402 receives peer discovery signals from the wireless devices 404-414. From the wireless device 404, the wireless device 402 receives a peer discovery signal on resources corresponding to a first PDRID (PDRID1). From the wireless device 406, the wireless device 402 receives a peer discovery signal on resources corresponding to a second PDRID (PDRID2). From the wireless device 408, the wireless device 402 receives a peer discovery signal on resources corresponding to a third PDRID (PDRID3). From the wireless device 410, the wireless device 402 receives a peer discovery signal on resources corresponding to a fourth PDRID (PDRID4). From the wireless device 412, the wireless device 402 receives a peer discovery signal on resources corresponding to a fifth PDRID (PDRID5). From the wireless device 414, the wireless device 402 receives a peer discovery signal on resources corresponding to a sixth PDRID (PDRID6). The wireless device 402 is assigned to PDRID7.

In the exemplary method, the wireless device 402 receives a peer discovery signal from the wireless device 406 on a first resource associated with the PDRID2, determines whether to relay the peer discovery signal, and sends the peer discovery signal on a second resource associated with the PDRID2 upon determining to relay the peer discovery signal. The second resource is also utilized by the wireless device 406 to send the peer discovery signal. Through the exemplary method, the wireless device 414 is able to receive the peer discovery signal for wireless device 406 even through the wireless device 414 is outside the range to receive the peer discovery signal directly from the wireless device 406.

The wireless device 402 may determine whether to relay a peer discovery signal based on whether the peer discovery signal is decodable. For example, if the peer discovery signal from the wireless device 408 is not decodable, the wireless device 402 may determine not to relay the peer discovery signal sent from the wireless device 408. The wireless device 402 may determine whether to relay a decodable peer discovery signal based on a signal strength of the peer discovery signal and/or a comparison of the signal strength of the peer discovery signal with signal strengths of other peer discovery signals. For example, the wireless device 402 may rank signal strengths of decodable peer discovery signals received from the wireless devices 404, 406, 410, 412, and 414 and relay only those decodable peer discovery signals that are weakest or are close to be undecodable.

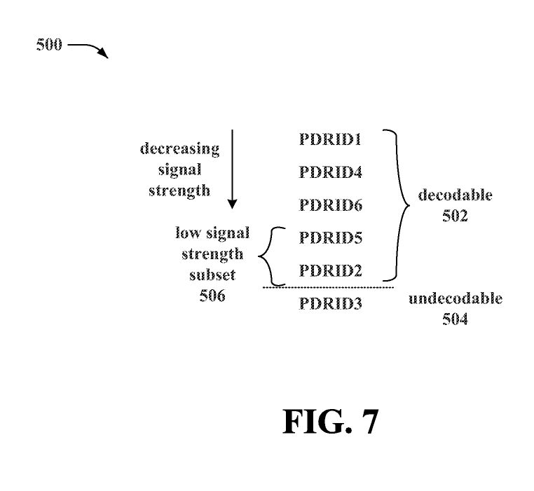

FIG. 7 is a diagram 500 for illustrating an exemplary method. The wireless device 402 may determine whether to relay a received peer discovery signal based on rankings of signal strengths of other received decodable peer discovery signals. For example, the wireless device 402 may determine the signal strengths of the decodable peer discovery signals received on each of the PDRIDs. The wireless device 402 may then rank the decodable peer discovery signals based on the determined signal strengths. As shown in FIG. 7, the wireless device 402 ranks the signal strengths of the decodable peer discovery signals 502 in the order of PDRID1, PDRID4, PDRID6, PDRID 5, and PDRID 2 with decreasing signal strengths. The signal strength of the peer discovery signal 504 on resources corresponding to PDRID3 is unranked as that peer discovery signal is undecodable. The wireless device 402 may determine a subset 506 of peer discovery signals with the lowest signal strength (e.g., lowest 5% of the weakest PDRIDs) and select a peer discovery signal to relay from the subset 506. The wireless device 402 may select for relaying the peer discovery signal with the lowest signal strength in the subset 506. In such a configuration, the wireless device 402 would select to relay the peer discovery signal received on resources associated with the PDRID2. The wireless device 402 may randomly select the peer discovery signal to relay from the subset 506. In such a configuration, the wireless device 402 may select to relay either of the peer discovery signals received on resources associated with the PDRIDs PDRID5 and PDRID2.

The wireless device 402 may select more than one peer discovery signal to relay. However, relaying multiple peer discovery signals would increase the energy consumption of the wireless device 402 and also reduce the number of peers the wireless device 402 could discover. Upon selecting to relay a peer discovery signal, the wireless device 402 may continue to relay the peer discovery signal for a specific period, such as for example, an ultraframe. Alternatively, the wireless device 402 may relay a peer discovery signal only once before performing the selection process again.

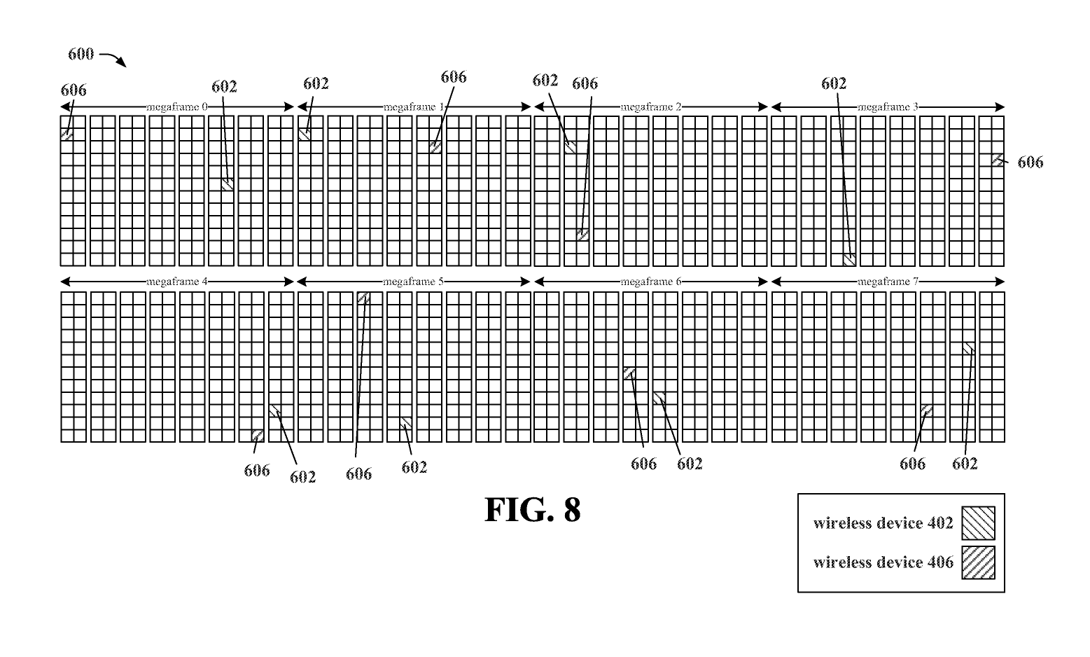

FIG. 8 is a diagram 600 for illustrating resources (e.g., blocks) utilized by a first wireless device 402 for relaying/transmitting peer discovery signals and a second wireless device 406 for transmitting peer discovery signals. The resources 602 utilized for transmitting peer discovery signals by the wireless device 402 are shown with a back diagonal pattern and the resources 606 utilized for transmitting peer discovery signals by the wireless device 406 are shown with a forward diagonal pattern. As shown in FIG. 8, the wireless device 406 transmits a peer discovery signal on the identified resources 606 associated with PDRID2 in each of the megaframes. The wireless device 402 transmits a peer discovery signal on the identified resources 602 associated with PDRID7 in each of the megaframes. The wireless device 402 listens for peer discovery signals on all other resources other than the resources 602. As discussed in relation to FIG. 5, the utilized resource may hop to a different resource in each of the megaframes. For convenience, only 8 megaframes are shown.

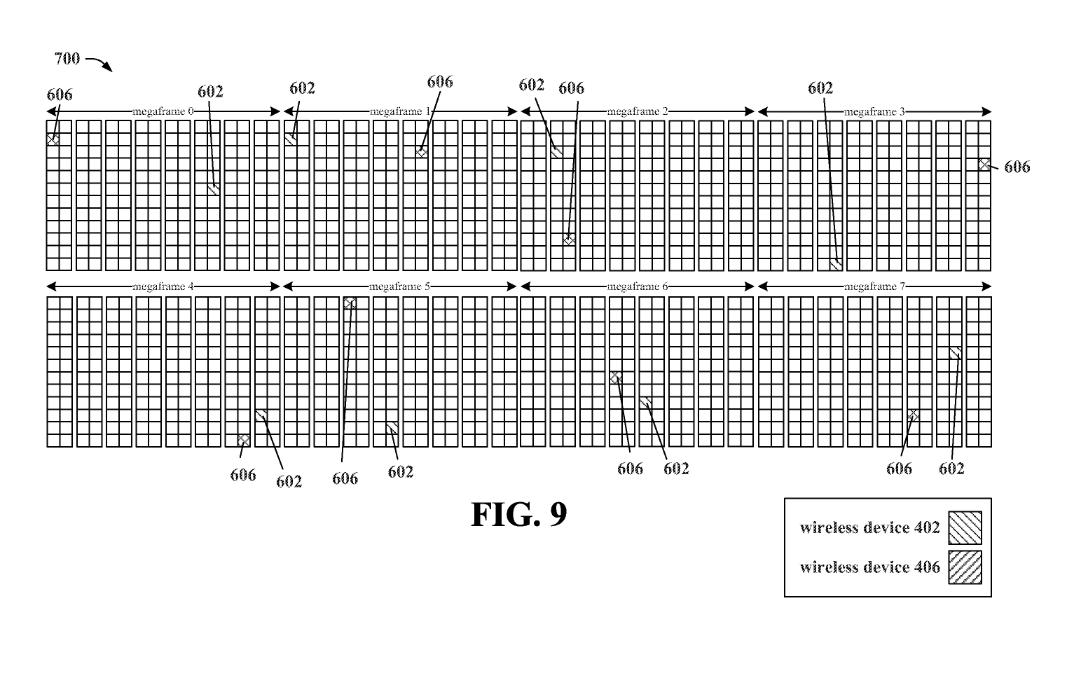

FIG. 9 is a diagram 700 for illustrating resources utilized by a first wireless device 402 for relaying/transmitting peer discovery signals and a second wireless device 406 for transmitting peer discovery signals. As shown in FIG. 9, the wireless device 402 may relay peer discovery signals for the wireless device 406 on the resources 606 associated with PDRID2. In such a configuration, the wireless device 402 selects a peer discovery signal to relay at a frequency of once for each peer discovery relaying opportunity (e.g., once each megaframe). As such, the peer discovery signal transmitted by the wireless device 402 is on top of each of the peer discovery signals transmitted by the wireless device 406. For all other devices listening on the resources 606, the two transmitted signals appear as one signal with a slightly different delay between the two transmitted signals, caused by the propagation difference, which can be absorbed by the cyclic prefix for OFDM based signals. Multiple devices might determine to forward peer discovery signals for wireless device 406 on the resources 606. In that case, on average, more users can hear (decode) the peer discovery messages for device 406 because all the signals sum up to a single signal with a larger power. In return, the peer discovery range is improved.

While on average, transmitting the peer discovery signal on top of another peer discovery signal greatly improves discovery range, the relay transmission may actually reduce the reception capability of some of the wireless devices in the network. Furthermore, if the peer discovery signal transmitted by the wireless device 402 is identical, other wireless devices would not know if the received peer discovery signal was sent from the wireless device assigned to the corresponding PDRID or from a relaying wireless device. As such, in such a configuration, multiple wireless devices may determine to relay the received relayed peer discovery signal, thus resulting in relay chain creating a peer discovery range expansion that is too large for effective peer-to-peer communication between the originating wireless device and any wireless device receiving the relayed peer discovery signal.

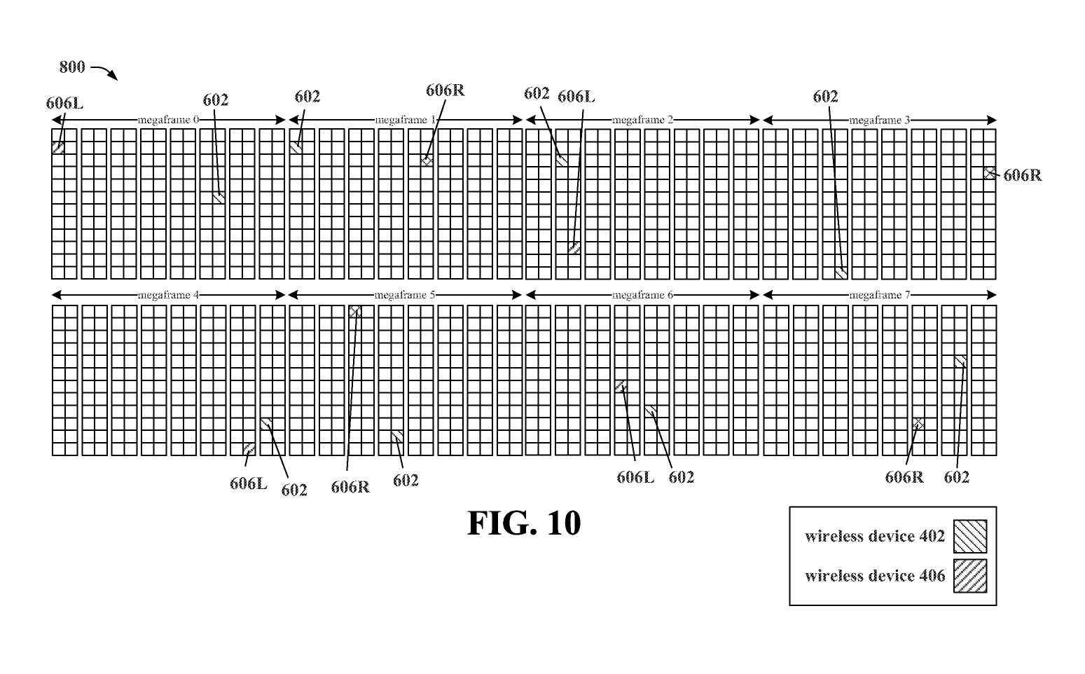

FIG. 10 is a diagram 800 for illustrating resources utilized by a first wireless device 402 for relaying/transmitting peer discovery signals and a second wireless device 406 for transmitting peer discovery signals. As shown in FIG. 10, the wireless device 402 selects a peer discovery signal to relay at a frequency of once for each of a plurality of peer discovery relaying opportunities (e.g., once every two megaframes). For example, the wireless device 402 only relays peer discovery signals in odd slots. In such a configuration, it is easy for other devices to distinguish an original signal, i.e., peer discovery signals from the original transmitter, from a relayed signal, because relaying is only permitted in a subset of the resources. By splitting the resources 606 into a listening subset of resources 606L and a relaying subset of resources 606R, a relay chain that causes the range expansion to be too large can be avoided. Furthermore, if the relay transmission is actually reducing the discovery range rather than increasing the discovery range, by relaying only in the relaying subset of resources 606R, the discovery range will be negatively affected only in the relaying subset of resources 606R.

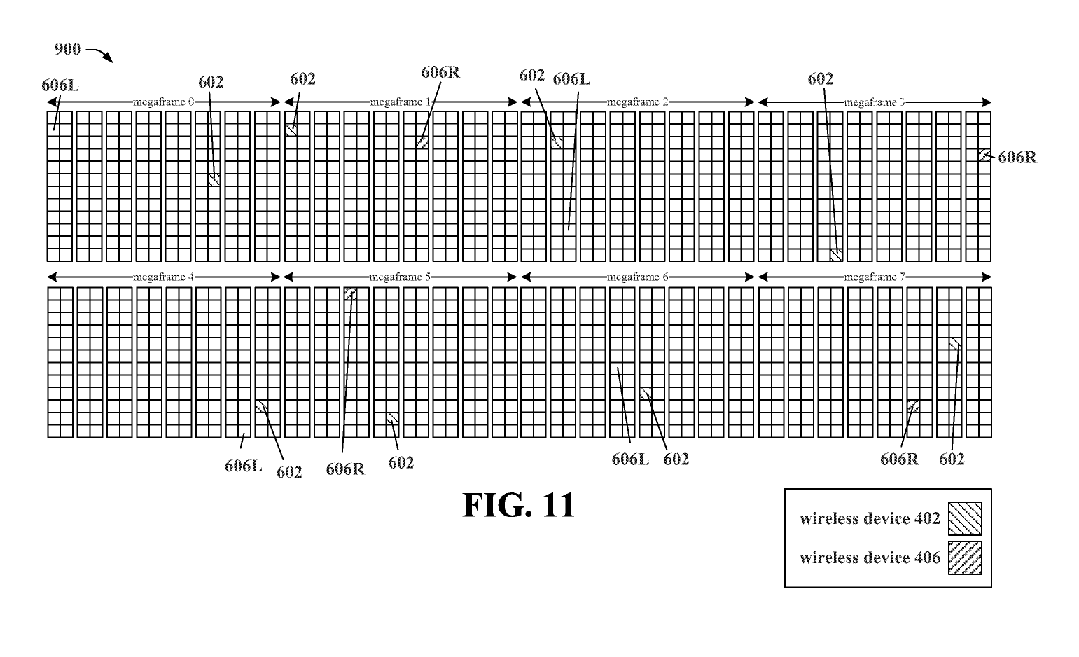

FIG. 11 is a diagram 900 for illustrating resources utilized by a first wireless device 402 for relaying/transmitting peer discovery signals and a second wireless device 406 for transmitting peer discovery signals. As shown in FIG. 11, the wireless device 414 receives peer discovery signals on the resources 606R associated with the PDRID2, but not on the resources 606L associated with the PDRID2. The wireless device 414 determines whether to relay the peer discovery signal based on whether the peer discovery signal is received in the listening subset of resources 606L. Because the peer discovery signal is not received in the listening subset of resources 606L, even though the peer discovery signal is received in the relay subset of resources 606R, the wireless device 414 determines not to relay the peer discovery signal. Even if the wireless device 414 receives the a peer discovery signal in the listening subset of resources 606L, if the peer discovery signal is not decodable, the wireless device 414 will determine not to relay the peer discovery signal.

As discussed supra, the relayed peer discovery signal is transmitted on top of the originally transmitting peer discovery signal. The aggregate signal at any receiver will appear as the sum of multiple copies of the same signal with different delays. This is similar to a signal passing through a multipath fading channel. The OFDM cyclic prefix can absorb the delay spread and the receiver will see a boost of the transmission power of the signal, which leads to a larger peer discovery range. The introduction of the relay node may create frequency selective fading even in stationary channel conditions. As such, the relay node may actually reduce the reception capability of some of the nodes in the network, although on average the relay node can greatly improve discovery range. There are two design options to mitigate the reduction of reception capability. First, as discussed supra, the resources may be split into a listening subset of resources 606L and a relaying subset of resources 606R. As discussed supra, splitting the resources accordingly also allows wireless devices to distinguish relayed and original peer discovery signals, thus preventing an original peer discovery signal from being relayed such that peer discovery range expansion is too large for effective peer-to-peer communication between the originating wireless device and any wireless device receiving the relayed peer discovery signal. Second, the reduction of reception capability may be mitigated by applying an additional random phase rotation to the peer discovery signal before relaying the peer discovery signal. In such a configuration, in each time period of a relay transmission, the wireless device would randomly determine a phase rotation and apply the determined phase rotation to the peer discovery signal before relaying the peer discovery signal. The application of a random phase rotation over time would prevent the frequency selective fading from persistently affecting the same set of users.

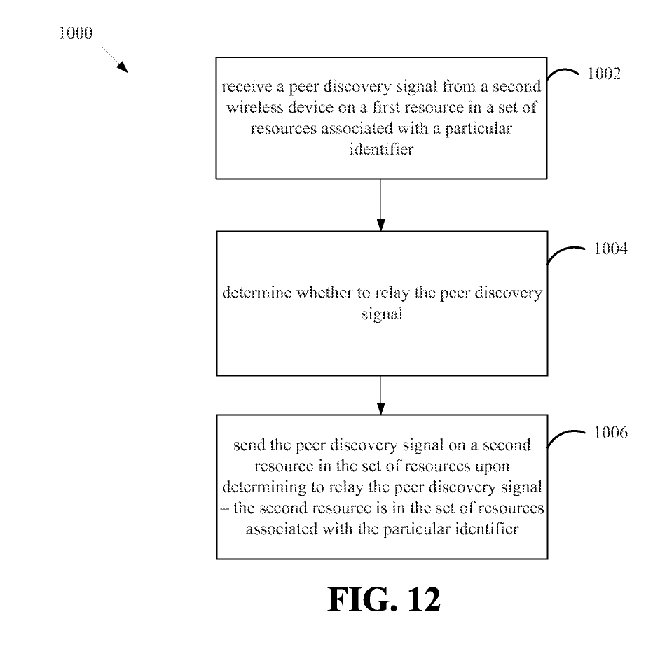

FIG. 12 is a flow chart 1000 of an exemplary method. The method is performed by a wireless device. As shown in FIG. 12, the wireless device receives a peer discovery signal from a second wireless device on a first resource in a set of resources associated with a particular identifier (1002). In addition, the wireless device determines whether to relay the peer discovery signal (1004). Furthermore, the wireless device sends the peer discovery signal on a second resource in the set of resources upon determining to relay the peer discovery signal (1006). The second resource is associated with the particular identifier and is the same resource on which the peer discovery signal is sent by the second wireless device (1006). For example, as shown in FIG. 10, the wireless device 402 receives a peer discovery signal from the wireless device 406 on a first resource 606L of megaframe 0 in a set of resources 606L, 606R associated with the identifier PDRID2. The wireless device 402 determines whether to relay the peer discovery signal. The wireless device 402 sends the peer discovery signal on a second resource 606R of megaframe 1 in the set of resources 606L, 606R upon determining to relay the peer discovery signal. The second resource 606R of megaframe 1 is associated with the identifier PDRID2 and is the same resource 606R of megaframe 1 on which the peer discovery signal is sent by the wireless device 406.

The wireless device may determine whether to relay the peer discovery signal based on whether the peer discovery signal is decodable and a signal strength of the peer discovery signal. The wireless device may determine whether to relay the peer discovery signal based on the signal strength of the peer discovery signal in comparison to a signal strength of each of one or more additionally received peer discovery signals. The set of resources 606L, 606R may include a listening subset of resources 606L and a relaying subset of resources 606R. In such a configuration, the wireless device sends the peer discovery signal only on the relaying subset of resources 606R. In another configuration, the set of resources 606L, 606R includes a listening subset of resources 606L and a relaying subset of resources 606R. In such a configuration, the wireless device determines whether to relay the peer discovery signal based on whether the peer discovery signal is received in the listening subset of resources 606L and is decodable.

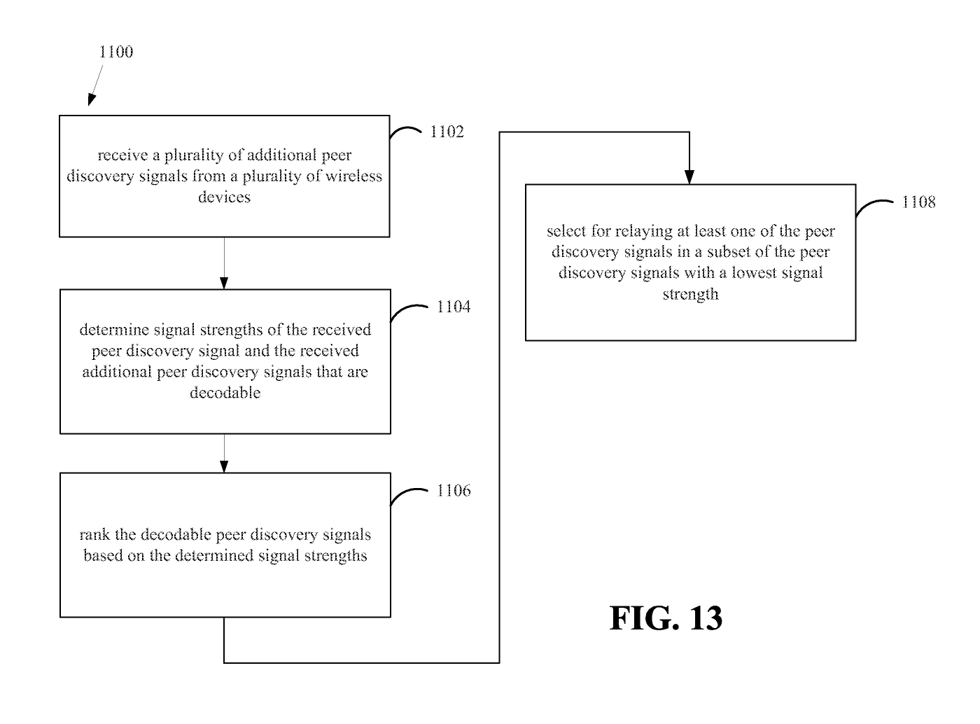

FIG. 13 is a flow chart 1100 of an exemplary method. The method is performed by a wireless device. As shown in FIG. 13, the wireless device receives a plurality of additional peer discovery signals from a plurality of wireless devices (1102). The wireless device determines signal strengths of the received peer discovery signal and the received additional peer discovery signals that are decodable (1104). The wireless device ranks the decodable peer discovery signals based on the determined signal strengths (1106). The wireless device then selects for relaying at least one of the peer discovery signals in a subset of the peer discovery signals with a lowest signal strength (1108). In one configuration, the selected at least one of the peer discovery signals are peer discovery signals with the lowest signal strength in the subset. The selecting step (1108) may be random within the subset and therefore the wireless device may randomly select for relaying the at least one of the peer discovery signals from the subset. The selecting step (1108) may be performed at a frequency of once for each of a plurality of peer discovery relaying opportunities, such as when the resources are split into a listening subset of resources and a relaying subset of resources. Alternatively, the selecting step (1108) may be performed at a frequency of once for each peer discovery relaying opportunity.

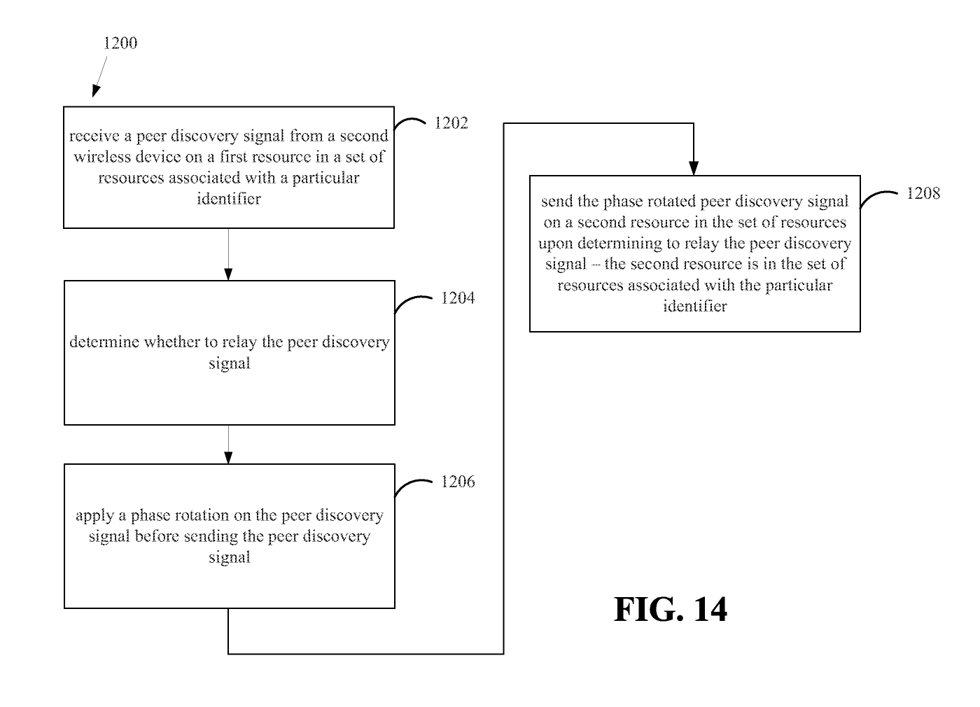

FIG. 14 is a flow chart 1200 of an exemplary method. The method is performed by a wireless device. As shown in FIG. 14, the wireless device receives a peer discovery signal from a second wireless device on a first resource in a set of resources associated with a particular identifier (1202). In addition, the wireless device determines whether to relay the peer discovery signal (1204). The wireless device then applies a phase rotation on the peer discovery signal before sending the peer discovery signal (1206). Furthermore, the wireless device sends the phase rotated peer discovery signal on a second resource in the set of resources upon determining to relay the peer discovery signal (1208). The second resource is associated with the particular identifier and is the same resource on which the peer discovery signal is sent by the second wireless device (1208).

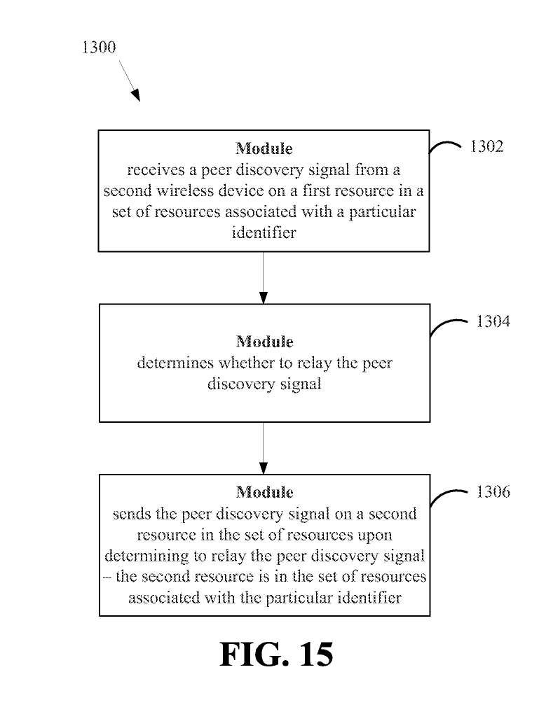

FIG. 15 is a conceptual block diagram 1300 illustrating the functionality of an exemplary apparatus 100. The apparatus 100 includes a module 1302 that receives a peer discovery signal from a second wireless device on a first resource in a set of resources associated with a particular identifier. The apparatus 100 further includes a module 1304 that determines whether to relay the peer discovery signal. The apparatus 100 further includes a module 1306 that sends the peer discovery signal on a second resource in the set of resources upon determining to relay the peer discovery signal. The second resource is associated with the particular identifier and is the same resource on which the peer discovery signal is sent by the second wireless device. The apparatus 100 may include additional modules that perform each of the steps in the aforementioned flow charts. As such, each step in the aforementioned flow charts may be performed by a module and the apparatus 100 may include one or more of those modules.

Referring to FIG. 1, in one configuration, the apparatus 100 for wireless communication includes means for receiving a peer discovery signal from a second apparatus on a first resource in a set of resources associated with a particular identifier. In addition, the apparatus 100 includes means for determining whether to relay the peer discovery signal. Furthermore, the apparatus 100 includes means for sending the peer discovery signal on a second resource in the set of resources upon determining to relay the peer discovery signal. The second resource is associated with the particular identifier and is the same resource on which the peer discovery signal is sent by the second apparatus. The apparatus 100 may further include means for receiving a plurality of additional peer discovery signals from a plurality of wireless devices, means for determining signal strengths of the received peer discovery signal and the received additional peer discovery signals that are decodable, means for ranking the decodable peer discovery signals based on the determined signal strengths, and means for selecting for relaying at least one of the peer discovery signals in a subset of the peer discovery signals with a lowest signal strength. The apparatus 100 may further include means for applying a phase rotation on the peer discovery signal before sending the peer discovery signal. The aforementioned means may be the processing system 114 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of operating a first wireless device, comprising:
receiving a peer discovery signal from a second wireless device on a first resource in a set of resources associated with a particular identifier;
determining whether to relay the peer discovery signal; and
sending the peer discovery signal on a second resource in the set of resources upon determining to relay the peer discovery signal, the second resource being associated with the particular identifier and being the same resource on which the peer discovery signal is sent by the second wireless device.

2. The method of claim 1, wherein the determining whether to relay the peer discovery signal is based on whether the peer discovery signal is decodable and a signal strength of the peer discovery signal.

3. The method of claim 2, wherein the determining is further based on the signal strength of the peer discovery signal in comparison to a signal strength of each of one or more additionally received peer discovery signals.

4. The method of claim 1, further comprising:
receiving a plurality of additional peer discovery signals from a plurality of wireless devices;
determining signal strengths of the received peer discovery signal and the received additional peer discovery signals that are decodable;
ranking the decodable peer discovery signals based on the determined signal strengths; and
selecting for relaying at least one of the peer discovery signals in a subset of the peer discovery signals with a lowest signal strength.

5. The method of claim 4, wherein the selected at least one of the peer discovery signals are peer discovery signals with the lowest signal strength in the subset.

6. The method of claim 4, wherein the selecting is random within the subset.

7. The method of claim 4, wherein the selecting is performed at a frequency of once for each of a plurality of peer discovery relaying opportunities.

8. The method of claim 4, wherein the selecting is performed at a frequency of once for each peer discovery relaying opportunity.

9. The method of claim 1, further comprising applying a phase rotation on the peer discovery signal before sending the peer discovery signal.

10. The method of claim 9, wherein the applied phase rotation is randomly determined over time.

11. The method of claim 1, wherein the set of resources comprise a listening subset of resources and a relaying subset of resources, and the first wireless device sends the peer discovery signal only on the relaying subset of resources.

12. The method of claim 1, wherein the set of resources comprise a listening subset of resources and a relaying subset of resources, and the determining whether to relay the peer discovery signal is determined based on whether the peer discovery signal is received in the listening subset of resources and is decodable.

13. An apparatus for wireless communication, comprising:
means for receiving a peer discovery signal from a second apparatus on a first resource in a set of resources associated with a particular identifier;
means for determining whether to relay the peer discovery signal; and
means for sending the peer discovery signal on a second resource in the set of resources upon determining to relay the peer discovery signal, the second resource being associated with the particular identifier and being the same resource on which the peer discovery signal is sent by the second apparatus.

14. The apparatus of claim 13, wherein the means for determining whether to relay the peer discovery signal is based on whether the peer discovery signal is decodable and a signal strength of the peer discovery signal.

15. The apparatus of claim 14, wherein the means for determining is further based on the signal strength of the peer discovery signal in comparison to a signal strength of each of one or more additionally received peer discovery signals.

16. The apparatus of claim 13, further comprising:
means for receiving a plurality of additional peer discovery signals from a plurality of wireless devices;
means for determining signal strengths of the received peer discovery signal and the received additional peer discovery signals that are decodable;
means for ranking the decodable peer discovery signals based on the determined signal strengths; and
means for selecting for relaying at least one of the peer discovery signals in a subset of the peer discovery signals with a lowest signal strength.

17. The apparatus of claim 16, wherein the selected at least one of the peer discovery signals are peer discovery signals with the lowest signal strength in the subset.

18. The apparatus of claim 16, wherein the means for selecting is random within the subset.

19. The apparatus of claim 16, wherein the means for selecting is performed at a frequency of once for each of a plurality of peer discovery relaying opportunities.

20. The apparatus of claim 16, wherein the means for selecting is performed at a frequency of once for each peer discovery relaying opportunity.

21. The apparatus of claim 13, further comprising means for applying a phase rotation on the peer discovery signal before sending the peer discovery signal.

22. The apparatus of claim 21, wherein the applied phase rotation is randomly determined over time.

23. The apparatus of claim 13, wherein the set of resources comprise a listening subset of resources and a relaying subset of resources, and the apparatus sends the peer discovery signal only on the relaying subset of resources.

24. The apparatus of claim 13, wherein the set of resources comprise a listening subset of resources and a relaying subset of resources, and the determining whether to relay the peer discovery signal is determined based on whether the peer discovery signal is received in the listening subset of resources and is decodable.

25. A computer program product in a first wireless device, comprising:
a computer-readable medium comprising code for:
receiving a peer discovery signal from a second wireless device on a first resource in a set of resources associated with a particular identifier;
determining whether to relay the peer discovery signal; and
sending the peer discovery signal on a second resource in the set of resources upon determining to relay the peer discovery signal, the second resource being associated with the particular identifier and being the same resource on which the peer discovery signal is sent by the second wireless device.

26. The computer program product of claim 25, wherein the code for determining whether to relay the peer discovery signal makes the determination based on whether the peer discovery signal is decodable and a signal strength of the peer discovery signal.

27. The computer program product of claim 26, wherein the code for determining makes the determination based on the signal strength of the peer discovery signal in comparison to a signal strength of each of one or more additionally received peer discovery signals.

28. The computer program product of claim 25, wherein the computer-readable medium further comprises code for:
receiving a plurality of additional peer discovery signals from a plurality of wireless devices;
determining signal strengths of the received peer discovery signal and the received additional peer discovery signals that are decodable;
ranking the decodable peer discovery signals based on the determined signal strengths; and
selecting for relaying at least one of the peer discovery signals in a subset of the peer discovery signals with a lowest signal strength.

29. The computer program product of claim 28, wherein the selected at least one of the peer discovery signals are peer discovery signals with the lowest signal strength in the subset.

30. The computer program product of claim 28, wherein the code for selecting selects randomly within the subset.

31. The computer program product of claim 28, wherein the code for selecting performs the selection at a frequency of once for each of a plurality of peer discovery relaying opportunities.

32. The computer program product of claim 28, wherein the code for selecting performs the selection at a frequency of once for each peer discovery relaying opportunity.

33. The computer program product of claim 25, wherein the computer-readable medium further comprises code for applying a phase rotation on the peer discovery signal before sending the peer discovery signal.

34. The computer program product of claim 33, wherein the applied phase rotation is randomly determined over time.

35. The computer program product of claim 25, wherein the set of resources comprise a listening subset of resources and a relaying subset of resources, and the first wireless device sends the peer discovery signal only on the relaying subset of resources.

36. The computer program product of claim 25, wherein the set of resources comprise a listening subset of resources and a relaying subset of resources, and the determining whether to relay the peer discovery signal is determined based on whether the peer discovery signal is received in the listening subset of resources and is decodable.

37. An apparatus for wireless communication, comprising:
a processing system configured to:
receive a peer discovery signal from a second apparatus on a first resource in a set of resources associated with a particular identifier;
determine whether to relay the peer discovery signal; and
send the peer discovery signal on a second resource in the set of resources upon determining to relay the peer discovery signal, the second resource being associated with the particular identifier and being the same resource on which the peer discovery signal is sent by the second apparatus.

38. The apparatus of claim 37, wherein the processing system is configured to determine whether to relay the peer discovery signal based on whether the peer discovery signal is decodable and a signal strength of the peer discovery signal.

39. The apparatus of claim 38, wherein the processing system is configured to determine whether to relay the peer discovery signal further based on the signal strength of the peer discovery signal in comparison to a signal strength of each of one or more additionally received peer discovery signals.

40. The apparatus of claim 37, wherein the processing system is further configured to:
receive a plurality of additional peer discovery signals from a plurality of wireless devices;
determine signal strengths of the received peer discovery signal and the received additional peer discovery signals that are decodable;
rank the decodable peer discovery signals based on the determined signal strengths; and
select for relaying at least one of the peer discovery signals in a subset of the peer discovery signals with a lowest signal strength.

41. The apparatus of claim 40, wherein the selected at least one of the peer discovery signals are peer discovery signals with the lowest signal strength in the subset.

42. The apparatus of claim 40, wherein the processing system is configuration to select randomly within the subset.

43. The apparatus of claim 40, wherein the processing system is configured to perform the selection at a frequency of once for each of a plurality of peer discovery relaying opportunities.

44. The apparatus of claim 40, wherein the processing system is configured to perform the selection at a frequency of once for each peer discovery relaying opportunity.

45. The apparatus of claim 37, wherein the processing system is further configured to apply a phase rotation on the peer discovery signal before sending the peer discovery signal.

46. The apparatus of claim 45, wherein the applied phase rotation is randomly determined over time.

47. The apparatus of claim 37, wherein the set of resources comprise a listening subset of resources and a relaying subset of resources, and the apparatus sends the peer discovery signal only on the relaying subset of resources.

48. The apparatus of claim 37, wherein the set of resources comprise a listening subset of resources and a relaying subset of resources, and the determining whether to relay the peer discovery signal is determined based on whether the peer discovery signal is received in the listening subset of resources and is decodable.
